(19) United States
(12) Patent Application Publication
(10) Pub. No.: US 2025/0285437 A1
(43) Pub. Date: Sep. 11, 2025

(54) IMAGE PROCESSING APPARATUS, CONTROL METHOD FOR THE SAME, IMAGE CAPTURING APPARATUS, AND IMAGE CAPTURING SYSTEM

(71) Applicant: CANON KABUSHIKI KAISHA, Tokyo (JP)

(72) Inventor: MINAKO KAMIYAMA, Tokyo (JP)

(21) Appl. No.: 19/062,211

(22) Filed: Feb. 25, 2025

(30) Foreign Application Priority Data
Mar. 6, 2024 (JP) 2024-034181

(51) Int. Cl. G06V 20/20; G06T 7/73; G06T 7/90; G06T 11/00; G06V 10/56; G06V 10/62; G06V 10/764; G06V 10/80; G06V 20/40; G06V 20/56

(52) U.S. Cl. CPC G06V 20/20; G06T 7/74; G06T 7/90; G06T 11/00; G06V 10/56; G06V 10/62; G06V 10/764; G06V 10/806; G06V 20/41; G06V 20/56; G06T 2207/10024; G06T 2207/30204

(57) ABSTRACT

An image processing apparatus obtains a visible light video and an invisible light video. The apparatus detects cyclicity of a temporal change of one or more lights included in the visible light video and/or the invisible light video, detects a color of the one or more lights from the visible light video, identifies a type of at least one light of the one or more lights based on the detected cyclicity and the detected color, and overlaps information regarding the identified type on the invisible light video.

### BACKGROUND OF THE INVENTION

### Cross-Reference to Priority Application

This application claims the benefit of Japanese Patent Application No. 2024-034181, filed Mar. 6, 2024, which is hereby incorporated by reference herein in its entirety.

### Field of the Invention

The present invention relates to a monitoring technology of a surrounding environment at night.

### Description of the Related Art

On the sea, a navigation mark (light tower, light buoy, and the like) for indicating a sea route for a vessel, a navigation light for indicating an orientation of a self vessel with respect to another vessel, and the like are used. For example, by emitting a light having a predetermined color or lighting pattern at night, the navigation mark notifies surroundings of information regarding the navigation mark (port mark, starboard mark, and the like). The navigation light is a light of a predetermined color installed at a predetermined place (left (port) side, right (starboard) side, masthead, and the like) of the vessel, and has a role of notifying surroundings of a direction in which the self vessel is heading by emitting light at night. Japanese Patent Laid-Open No. 2009-61952 and Japanese Patent Laid-Open No. 2010-160626 disclose a technology in which a vessel blinks a light source based on an identification code unique to the vessel, and the blinking of the light source is detected by an image capturing apparatus to individually recognize the vessel.

An invisible light image capturing apparatus such as a thermal camera may be used to monitor the surrounding environment at night. However, a video obtained by the invisible light image capturing apparatus generally has a low spatial resolution and cannot obtain color information. Therefore, it is not possible for a user to monitor the video obtained by the invisible light image capturing apparatus and identify the information indicated by the above-described navigation mark and navigation light. On the other hand, there is a problem that it becomes complicated for the user to monitor both a video of a visible light image capturing apparatus and a video of an invisible light image capturing apparatus.

### SUMMARY OF THE INVENTION

According to one aspect of the present invention, an image processing apparatus comprises: one or more memories storing instructions; and one or more processors executing the instructions to obtain a visible light video generated by a visible light image capturing unit that performs image capturing in a wavelength range of visible light; obtain an invisible light video generated by an invisible light image capturing unit that performs image capturing in a wavelength range different from the wavelength range of the visible light; detect cyclicity of a temporal change of one or more lights included in a video from the video of at least one of the visible light video and the invisible light video; detect a color of the one or more lights from the visible light video; identify a type of at least one light of the one or more lights based on the detected cyclicity and the detected color; and overlap information regarding the identified type on the invisible light video.

The present invention facilitates monitoring of a surrounding environment at night.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view illustrating a functional configuration of an image capturing apparatus.

FIG. 2 is a flowchart showing operation of the image capturing apparatus.

FIG. 3 is a detailed flowchart of navigation mark identification (S206).

FIG. 4 is a view illustrating an example of a light color and a lighting manner according to the type of a navigation mark.

FIGS. 5A and 5B are views describing a frame group when a flashing light and a group flashing light are photographed.

FIGS. 6A and 6B are views describing lighting patterns of navigation marks.

FIG. 7 is a detailed flowchart of navigation light identification (S207).

FIGS. 8A and 8B are views describing how navigation lights of a vessel traveling rightward and leftward look.

FIG. 9 is a view describing a situation of another vessel according to how navigation lights look.

FIGS. 10A to 10C are views illustrating examples of information overlap on navigation marks.

FIGS. 11A and 11B are views illustrating examples of information overlap on vessels.

FIG. 12 is a block diagram illustrating a hardware configuration example of a computer apparatus applicable to an image capturing apparatus.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

As a first embodiment of an image processing apparatus according to the present invention, an image capturing apparatus configured to perform photographing with invisible light will be described below as an example. Note that the following description will be given with a port mark and a starboard mark as examples of navigation marks, and a left side light/a right side light and a masthead light as examples of the types of navigation lights. However, the present invention can also be applied to other types of navigation marks and navigation lights.

### Apparatus Configuration

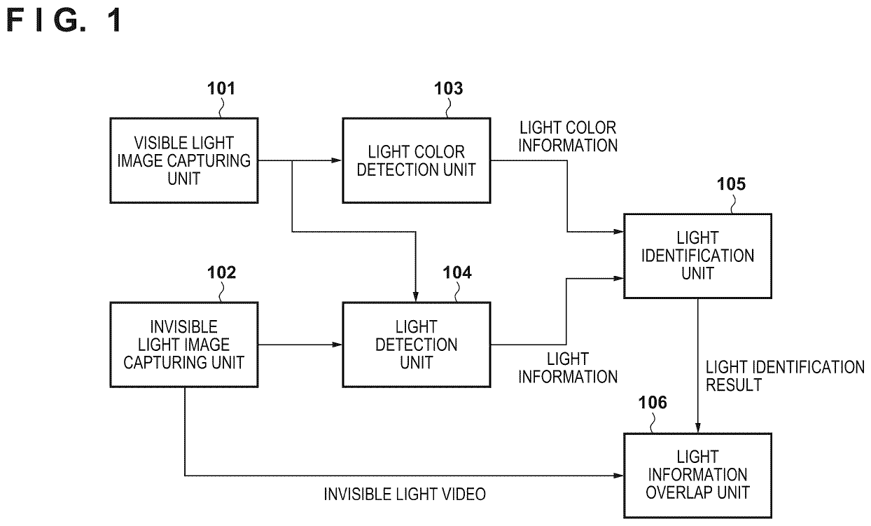

FIG. 1 is a view illustrating a functional configuration of an image capturing apparatus. The image capturing apparatus includes a visible light image capturing unit 101, an invisible light image capturing unit 102, a light color detection unit 103, a light detection unit 104, a light identification unit 105, and a light information overlap unit 106.

The visible light image capturing unit 101 is an image capturing unit configured to perform image capturing in a visible light range (e.g., the wavelength is 380 nm to 780 nm) and obtain a video (RGB color video or the like) that can express the color. In a video (visible light video) obtained by photographing the sea at night by the visible light image capturing unit 101, lights such as navigation marks and navigation lights appear including colors, but the structure/shape of navigation marks and vessels do not substantially appear. Note that exposure setting may be setting in which the influence of noise is reduced, the light image is not overexposed, and/or the influence of flicker of the light emitter (light bulb or LED) of a light is reduced so that the color of the light can be easily identified.

The invisible light image capturing unit 102 is an image capturing unit configured to perform image capturing in an invisible light range (e.g., wavelength range excluding the visible light range) to obtain a monochrome video. For example, a thermal camera or the like can be used as the invisible light image capturing unit 102. In a video (invisible light video) obtained by photographing the sea at night by the invisible light image capturing unit 102, light emitters such as navigation marks and navigation lights, and the structure/shape of navigation marks and vessels. The spatial resolution of the invisible light video is lower than the spatial resolution of the visible light video, and the invisible light video does not have color information (defined by the visible light range).

Note that the following description assumes that the visible light image capturing unit 101 and the invisible light image capturing unit 102 simultaneously photograph substantially identical monitoring regions (image capturing regions), and assumes that identical lights in two videos can be associated based on the coordinate position in the visible light video and the coordinate position in the invisible light video. However, as long as identical lights in two videos can be associated, monitoring regions (image capturing regions) need not be substantially identical, and at least partial regions of the visible light video and the invisible light video may overlap each other.

The light color detection unit 103 detects and outputs, as light color information, the color of a light from the visible light video obtained by the visible light image capturing unit 101. The light detection unit 104 obtains and outputs, as light information, a light emission cycle, a lighting pattern, and a light position of a light from a visible light video and/or an invisible light video photographed by the visible light image capturing unit 101 and/or the invisible light image capturing unit 102. Note that regarding the obtainment of the light position, it is preferable to use a visible light video having a relatively high spatial resolution.

The light identification unit 105 identifies and outputs, as a light identification result, each light included in the visible light video based on the light color information obtained from the light color detection unit 103 and the light information obtained from the light detection unit 104. The light identification result includes, for example, information regarding the navigation mark type and information on the orientation of the vessel (based on a combination of navigation lights).

The light information overlap unit 106 overlaps, and outputs as an overlap video, the information included in the light identification result obtained from the light identification unit 105 on the invisible light video. Note that the light information overlap unit 106 itself may be configured to include a display unit (liquid crystal/organic EL display) and display an overlap video, or may be configured to transmit the overlap video to an external display apparatus.

### Apparatus Operation

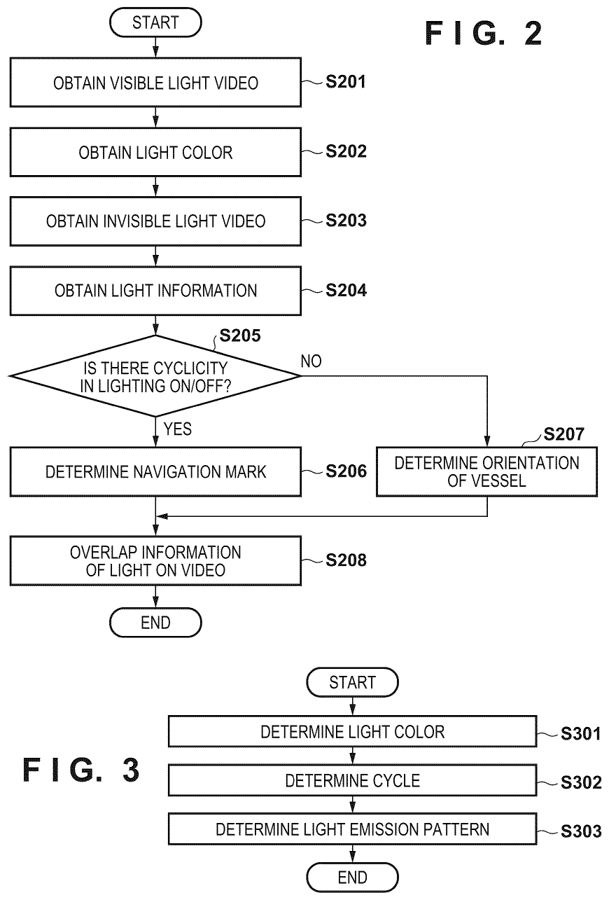

FIG. 2 is a flowchart showing the operation of the image capturing apparatus. The following operation is started when a monitoring operation by the image capturing apparatus is instructed by the user.

In S201, the visible light image capturing unit 101 starts obtainment of a visible light video. In S202, the light color detection unit 103 detects the light color of the light included in the visible light video obtained in S201.

In S203, the invisible light image capturing unit 102 starts obtainment of the invisible light video. In S204, the light detection unit 104 detects light information of the light included in the video from the visible light video obtained in S201 and/or the invisible light video obtained in S203. Here, as the light information, information on the light emission cycle, the lighting pattern, and the light position of each light included in the video is detected.

In S205, the light detection unit 104 determines whether or not there is cyclicity in the temporal change of a lighting state (lighting on/off) of each light included in the video from the light information detected in S204. If there is cyclicity, it is judged to be the light of a navigation mark, and the process proceeds to S206. If there is no cyclicity (e.g., constantly on), it is judged to be the light of a navigation light, and the process proceeds to S207.

In S206, the light identification unit 105 identifies the type of the navigation mark corresponding to the light based on the light color detected by the light color detection unit 103 and the light information (light emission cycle and light emission pattern) detected by the light detection unit 104.

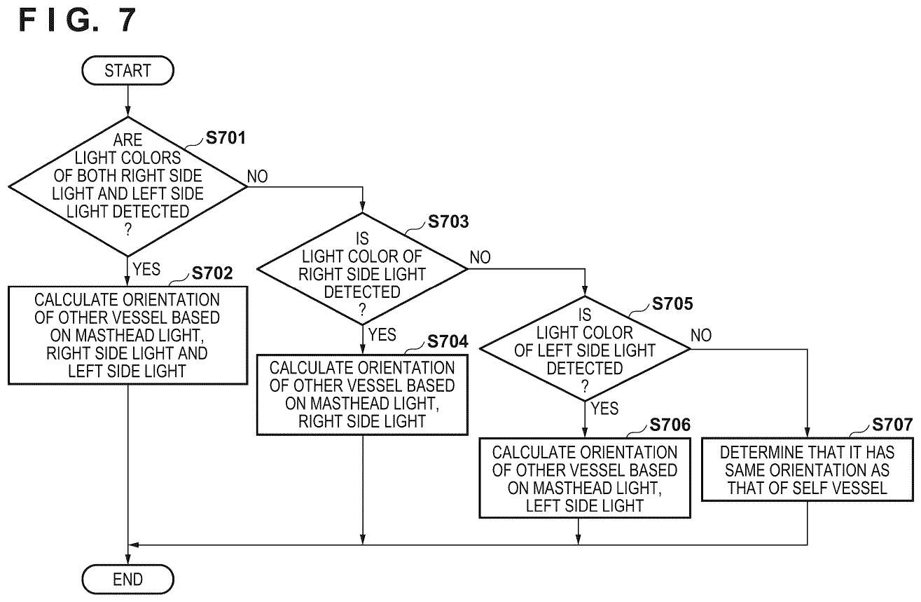

In S207, the light identification unit 105 identifies the orientation of the vessel from the light information (light position) detected by the light detection unit 104 and the light color detected by the light color detection unit 103 for each light. Although details will be described later with reference to FIGS. 7 to 9, in S207, the orientation of the vessel corresponding to a plurality of lights is identified based on a combination of colors of the plurality of lights.

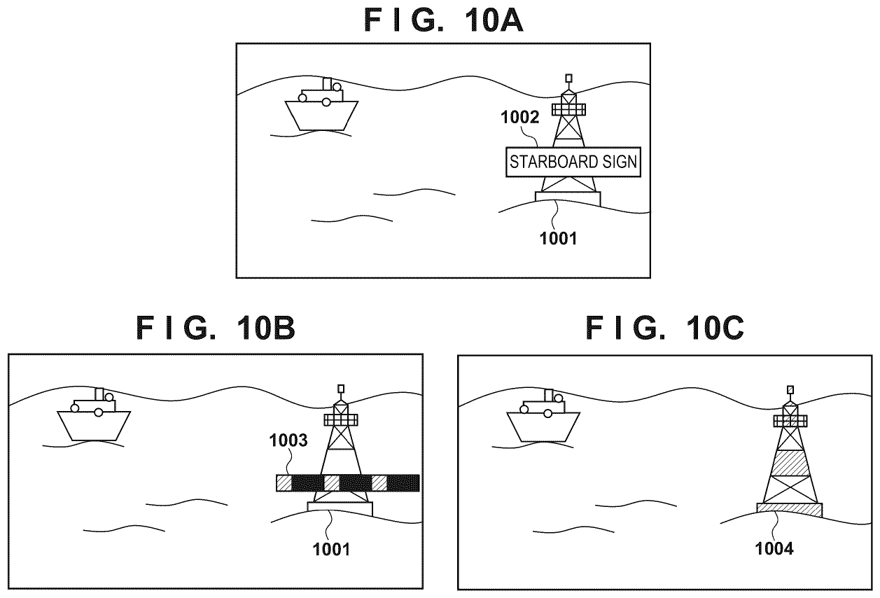

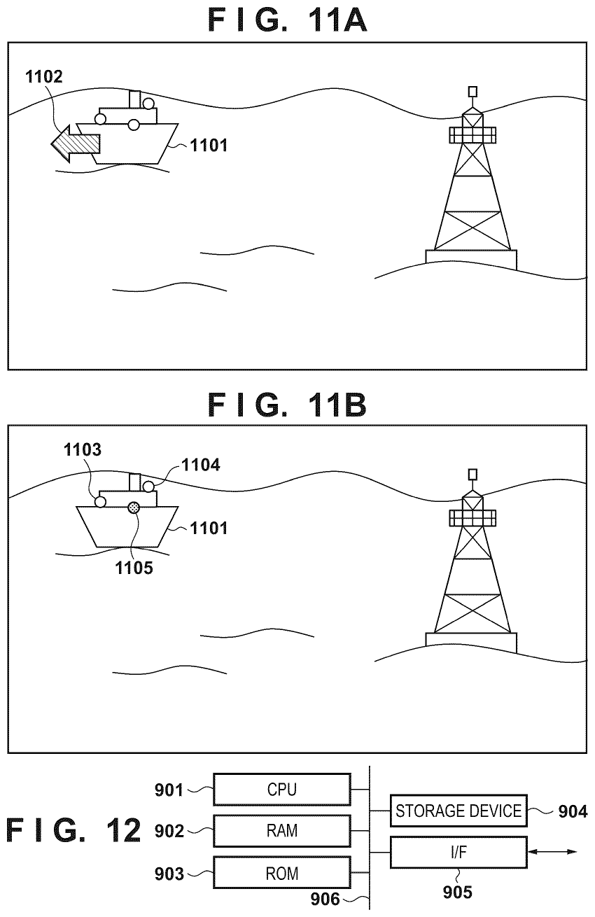

In S208, the light information overlap unit 106 overlaps information based on the light identification result obtained by the identification (determination) in S206 and/or S207 on the invisible light video. Details will be described later with reference to FIGS. 10A to 11B.

### Navigation Mark Identification

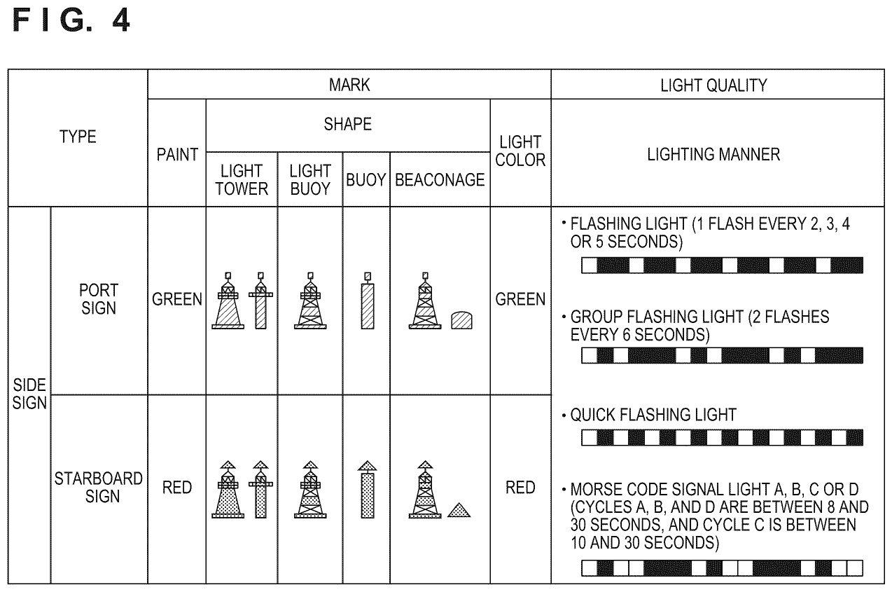

Hereafter, an outline of the navigation mark will be first described with reference to FIGS. 4 to 6B, and then details of the navigation mark identification (S206) will be described with reference to FIG. 3.

The navigation mark has a form such as a light tower, a light buoy, a buoy, or beaconage, and a type (port mark, starboard mark, and the like described later) is set for each navigation mark. In the daytime, the type of the navigation mark can be discriminated by the paint and shape of the navigation mark, and at night, the type of the navigation mark can be discriminated by the light color and lighting manner of the light.

FIG. 4 is a view illustrating an example of a light color and a lighting manner (lighting pattern) according to the type of the navigation mark. Here, among many types of navigation marks, a port mark and a starboard mark will be described regarding examples. Note that the port mark is a navigation mark indicating that the position of the mark is the left end of the sea route. The starboard mark is a navigation mark indicating that the position of the mark is the right end of the sea route.

The port mark is painted “green” and the starboard side mark is painted “red”. At night, the starboard mark emits light in “green”, and the port mark emits light in “red”. Examples of the lighting manner include a flashing light, a group flashing light, a quick flashing light, and a Morse code signal.

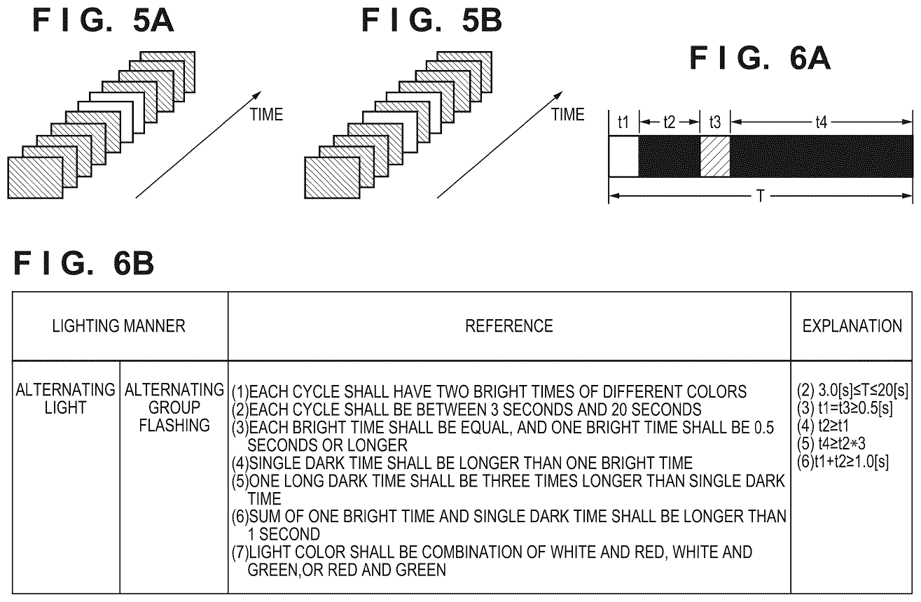

FIGS. 5A and 5B are views describing a frame group when a flashing light and a group flashing light are photographed. FIG. 5A illustrates a frame for one cycle when a flashing light is photographed, and FIG. 5B illustrates a frame for one cycle when a group flashing light is photographed. A photographing frame rate when a visible light video and an invisible light video are obtained may be set to 30 fps or more so that the group flashing light can be appropriately identified.

When photographing at a frame rate of 30 fps, 150 frame cycles can be determined to be a cycle of 5 seconds, and 180 frame cycles can be determined to be a cycle of 6 seconds. If light frames (frames indicated in white) are concentrated in one place within one cycle as illustrated in FIG. 5A, it can be determined as a flashing light, and if light frames are separated in two places as illustrated in FIG. 5B, it can be determined as a group flashing light.

FIGS. 6A and 6B are views describing lighting patterns (lighting manner) of navigation marks. Note that FIGS. 6A and 6B illustrate examples of the reference of an alternating light in which lights of two different colors are alternately on, but the reference of the time periods between bright times and dark times is similarly set in the flashing light and the group flashing light.

FIG. 6A exemplarily illustrates a lighting manner, and FIG. 6B illustrates a reference of the lighting manner (reference of the time periods between bright times and dark times). For example, in a case of an alternating light, there is a reference that two bright times exist in one cycle and the time period between each bright time is 0.5 seconds or more, and one single time period between dark times is one time period between bright times or more.

Therefore, in FIG. 6A, when t1=t3=0.5 [s], t2=0.5 [s], and t4=1.5 [s] are set, the cycle T=3 [s] is obtained. When this is photographed at a frame rate of 30 fps, t1 and t3 are 15 frames, t2 is 15 frames, and t4 is 45 frames, and all the time periods between bright times and between dark times are photographed in 90 frames.

FIG. 3 is a detailed flowchart of navigation mark identification (S206). As described above, here, for each light having cyclicity in the lighting state, the type of the navigation mark (here, a port sign or a starboard sign) indicated by the light is discriminated.

In S301, the light identification unit 105 obtains the light color of the light currently being gazed at. The information obtained in S202 may be used, or a visible light video may be newly determined and obtained.

In S302, the light identification unit 105 determines the cycle of the lighting state of the light currently being gazed at. Specifically, the cycle is determined based on a plurality of consecutive frames included in the visible light video and/or the invisible light video.

In S303, the light identification unit 105 determines the light emission pattern of the light currently being gazed at. Specifically, the light emission pattern is determined based on a plurality of consecutive frames included in the visible light video and/or the invisible light video. When the light emission pattern is uniquely determined, the corresponding navigation mark type (here, a port sign or a starboard sign) is discriminated.

### Navigation Light Identification

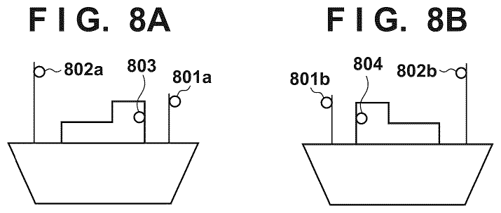

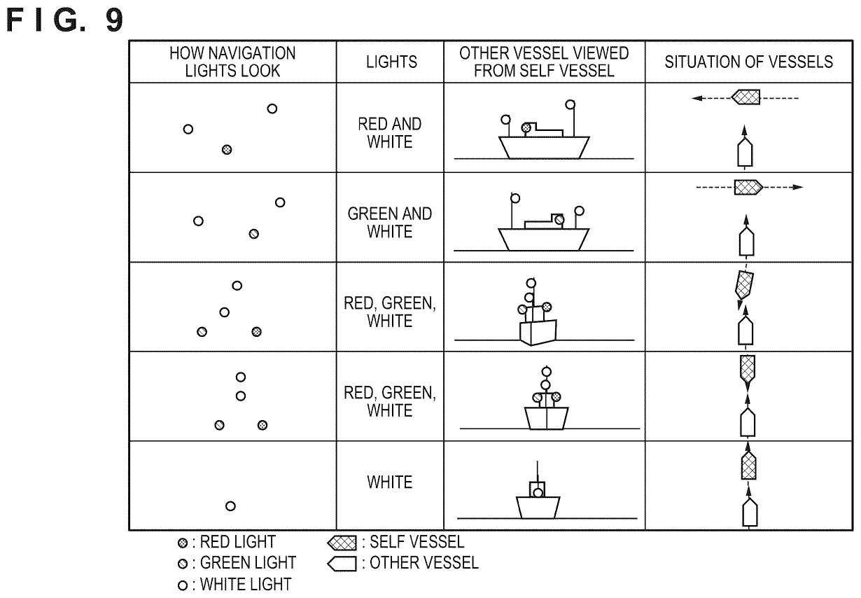

Hereafter, an outline of a navigation light will be first described with reference to FIGS. 8A to 9, and then details of the navigation light identification (S207) will be described with reference to FIG. 7. The navigation light is a light of a predetermined color installed at a predetermined place (left (port) side, right (starboard) side, masthead, and the like) of the vessel, and has a role of notifying surroundings (other vessels or the like) of a direction in which the self vessel is heading by emitting light at night.

FIGS. 8A and 8B are views describing how navigation lights of a vessel traveling rightward and leftward look as viewed from an observer. A vessel navigates with the navigation light on during navigation (from sunset to sunrise). There are several places where navigation lights are installed, FIGS. 8A and 8B illustrate a case where a front masthead light 801, a rear masthead light 802, a right side light 803, and a left side light 804 are installed.

It is prescribed by law that the color of the masthead lights (the front masthead light 801 and the rear masthead light 802) is “white”, the color of the right side light 803 is “green”, and the color of the left side light 804 is “red”. The lights of the masthead lights (the front masthead light 801 and the rear masthead light 802) emit light in a range of 112.5 degrees to the left and right (a total light projection range of 225 degrees) with the bow direction as a reference (0 degrees). On the other hand, the light of the right side light 803 emits light in a range of 112.5 degrees rightward with the bow direction as a reference, and the light of the left side light 804 emits light in a range of 112.5 degrees leftward with the bow direction as a reference. Therefore, when viewed from another vessel, when at least one of the right side light 803 and the left side light 804 is visible, both the front masthead light 801 and the rear masthead light 802 are visible together. Furthermore, the installation position (height from the sea surface) of the front masthead light 801 is at a position lower than the installation position of the rear masthead light 802.

FIG. 9 is a view describing a situation of another vessel according to how navigation light look from an observer (self vessel) (how they look in a visible light video). When in a state where the other vessel crosses the self vessel (the orientation of the self vessel and the orientation of the other vessel are substantially orthogonal), three lights are brought into a state of being visible to the self vessel. That is, when the other vessel is heading leftward, three lights of the left side light (red), the front masthead light (white), and the rear masthead light (white) are visible, and when the other vessel is heading rightward, three lights of the right side light (green), the front masthead light (white), and the rear masthead light (white) are visible.

Furthermore, it is indicated that the closer the distance between the position of the front masthead light and the position of the rear masthead light in a photographed video is, the closer the orientation of the other vessel and the orientation of the self vessel is to parallel (however, the other vessel faces the direction of the self vessel). That is, the distance between the position of the front masthead light and the position of the rear masthead light in the photographed video is the most separated when the orientation of the other vessel is orthogonal to the orientation of the self vessel. When the other vessel faces the direction of the self vessel, four lights (the right side light (green), the left side light (red), the front masthead light (white), and the rear masthead light (white)) of the other vessel are visible from the self vessel. Note that when the self vessel and the other vessel face the same direction, only a stern light (white) is visible. The stern light is a light that emits light in the stern direction (light projection range of 135 degrees rear to the vessel).

As understood from FIG. 9, the orientation of the other vessel can be determined based on the light colors and the positional relationship of the four lights (the right side light (green), the left side light (red), the front masthead light (white), and the rear masthead light (white)).

FIG. 7 is a detailed flowchart of navigation light identification (S207). The situation (orientation) of the other vessel is determined as follows according to the combination of the colors of the plurality of lights detected in the visible light video. Note that the light identification unit 105 determines that one or more lights having a mutual distance less than a predetermined distance in a video (visible light video or invisible light video) as one or more lights installed in identical vessels, and groups the one or more lights. The following process is performed for each group.

In S701, the light color detection unit 103 determines whether or not the light colors of both the right side light and the left side light (i.e., the green light and the red light) are detected in the visible light video. When both the green light and the red light are detected (the state of the third and fourth lines of FIG. 9), the process proceeds to S702, and when at least one of the green light and the red light is not detected (the state of the first, second, and fifth lines of FIG. 9), the process proceeds to S703. In S702, the light identification unit 105 calculates (determines) the orientation of the other vessel viewed from the self vessel based on the positions of the four lights (the right side light, the left side light, the front masthead light, and the rear masthead light) in the video.

In S703, the light color detection unit 103 determines whether or not the light color of the right side light (i.e., the green light) is detected in the visible light video. When the green light is detected (the state of the second line in FIG. 9), the process proceeds to S704, and when the green light is not detected (the state of the first and fifth lines in FIG. 9), the process proceeds to S705. In S704, the light identification unit 105 calculates (determines) the orientation of the other vessel viewed from the self vessel based on the positions of the three lights (the right side light, the front masthead light, and the rear masthead light) in the video.

In S705, the light color detection unit 103 determines whether or not the light color of the left side light (i.e., the red light) is detected in the visible light video. When the red light is detected (the state of the first line in FIG. 9), the process proceeds to S706, and when the red light is not detected (the state of the fifth line in FIG. 9), the process proceeds to S707.

In S706, the light identification unit 105 calculates (determines) the orientation of the other vessel viewed from the self vessel based on the positions of the three lights (the left side light, the front masthead light, and the rear masthead light) in the video. In S707, the light identification unit 105 determines that the other vessel is in the same orientation as that of the self vessel.

Note that in a small vessel, only one masthead light is installed, but even in this case, it is possible to calculate (determine) the orientation of the other vessel viewed from the self vessel based on the position of at least one of the right side light and the left side light and the position of the masthead light.

### Example of Information Overlap Display on Invisible Light Video

An example of information overlap performed by the light information overlap unit 106 in S208 will be described below. That is, an example in which information on the navigation mark and the vessel is overlapped on an invisible light video will be described.

FIGS. 10A to 10C are views illustrating three examples of information overlap on the navigation mark image in the invisible light video. A vessel and a navigation mark 1001 are assumed to appear in the invisible light videos in FIGS. 10A to 10C.

FIG. 10A illustrates an example in which a label 1002 of “starboard sign”, which is a navigation mark type of the navigation mark 1001, is overlapped and displayed on the navigation mark 1001 in the invisible light video. FIG. 10B illustrates an example in which a lighting pattern 1003 of the light of the navigation mark 1001 is overlapped and displayed on the navigation mark 1001 in the invisible light video. Furthermore, FIG. 10C illustrates an example in which a navigation mark image is colored and displayed 1004 in “paint” corresponding to the navigation mark type of the navigation mark 1001 on the navigation mark 1001 in the invisible light video.

In this manner, information regarding the navigation mark obtained from the visible light video is overlapped and displayed on the navigation mark image in the invisible light video. This allows the user to easily grasp surrounding navigation marks on the sea at night by monitoring only the invisible light video that is overlapped and displayed.

FIGS. 11A and 11B are views illustrating two examples of information overlap on a vessel image in the invisible light video. A vessel 1101 and navigation marks are assumed to appear in the invisible light videos in FIGS. 11A and 11B similarly to FIGS. 10A to 10C.

FIG. 11A illustrates an example in which an arrow 1102 indicating the orientation of the vessel is overlapped and displayed on the vessel 1101. That is, the arrow icon 1102 is overlapped and displayed so that the user can intuitively grasp that the vessel 1101 is heading (navigating) “leftward”. FIG. 11B illustrates an example in which navigation lights 1103 to 1105 are colored in the light colors corresponding to respective navigation lights of the vessel 1101. That is, here, the navigation lights 1103 and 1104, which are masthead lights, are colored with “white”, and the navigation light 1105, which is a left side light, is colored with “red”. That is, by viewing the invisible light video that is overlapped and displayed, the user can grasp the navigation lights of the vessel 1101 in the case of viewing the visible light video (color video).

In this manner, information regarding the navigation lights of the vessel obtained from the visible light video is overlapped and displayed on the vessel image in the invisible light video. This allows the user to easily grasp surrounding vessels on the sea at night by monitoring only the invisible light video that is overlapped and displayed.

As described above, according to the first embodiment, the information obtained in the visible light video is overlapped and displayed on the invisible light video. By monitoring the invisible light video having overlap display, the user can intuitively grasp the situation of the surroundings (photographing range by the invisible light image capturing unit 102) that is a monitoring target.

### Variation Example

Each functional unit of the image capturing apparatus illustrated in FIG. 1 may be implemented by hardware or may be implemented by software (computer program). In the former case, each functional unit may be implemented by hardware such as an ASIC or a programmable logic array (PLA). ASIC is an abbreviation for application specific integrated circuit. Note that some functional units of the functional units may be implemented by hardware.

In the latter case, a computer apparatus that can execute such a computer program is applicable to an image capturing apparatus. A hardware configuration example of a computer apparatus applicable to the image capturing apparatus will be described with reference to the block diagram of FIG. 12. As such a computer apparatus, a computer apparatus such as a PC, a tablet terminal apparatus, or a smartphone is applicable.

A CPU 901 performs various processes using computer programs and data stored in a RAM 902 or a ROM 903. By this, the CPU 901 controls the operation of the entire computer apparatus, and executes or controls various processes described as the processes performed by the image capturing apparatus. In place of the CPU 901, a programmable processor such as an MPU may be used. CPU is an abbreviation for central processing unit. MPU is an abbreviation for micro-processing unit.

The RAM 902 has an area for storing computer programs and data loaded from the ROM 903 and a storage device 904, and an area for storing computer programs and data received from the outside via an I/F 905. The RAM 902 also has a work area used when the CPU 901 performs various processes. The RAM 902 can thus provide various areas as appropriate.

The ROM 903 stores setting data of the computer apparatus, computer programs and data related to activation of the computer apparatus, computer programs and data related to basic operations of the computer apparatus, or the like.

A storage device 904 is a large-capacity information storage device such as a hard disk drive device. The storage device 904 saves an operating system (OS), computer programs and data for causing the CPU 901 to execute or control various processes described as processes performed by the image capturing apparatus, and the like. The computer program saved in the storage device 904 can also include a computer program for causing the CPU 901 to execute or control the functions of the functional units illustrated in FIG. 1. Images captured by the visible light image capturing unit 101 and the invisible light image capturing unit 102 may be saved in the storage device 904, and the CPU 901 may read the images and execute the process as necessary.

An I/F 905 is a communication interface for performing data communication with an external apparatus via a network such as a LAN or the Internet.

The CPU 901, the RAM 902, the ROM 903, the storage device 904, and the I/F 905 are all connected to a system bus 906. Note that the hardware configuration of the computer apparatus applicable to the image capturing apparatus is not limited to the configuration illustrated in FIG. 12, and can be appropriately modified/changed.

Note that the configuration of the system described in the embodiments described above can be appropriately modified or changed depending on specifications, various conditions (usage conditions, usage environment, and the like), and the like of the apparatus applied to the system, and the configuration described in the embodiments described above is merely an example.

The above-described image capturing apparatus may be mounted on a vessel or may be disposed on land (around a coast or the like). The invisible light video having the overlap display that is generated may be configured to be displayed on the display unit of the image capturing apparatus, or may be configured as an image capturing system to be displayed on a display unit of a client apparatus different from the image capturing apparatus. The image capturing apparatus and the client apparatus can communicate via any wired or wireless communication path (including a local connection and a remote connection via the Internet).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image processing apparatus comprising:
one or more memories storing instructions; and
one or more processors executing the instructions:
to obtain a visible light video generated by a visible light image capturing unit that performs image capturing in a wavelength range of visible light;
to obtain an invisible light video generated by an invisible light image capturing unit that performs image capturing in a wavelength range different from the wavelength range of the visible light;
to detect cyclicity of a temporal change of one or more lights included in a video from the video of at least one of the visible light video and the invisible light video;
to detect a color of the one or more lights from the visible light video;
to identify a type of at least one light of the one or more lights based on the detected cyclicity and the detected color; and
to overlap information regarding the identified type on the invisible light video.

2. The image processing apparatus according to claim 1, wherein a light detected to have cyclicity is identified as a light of a navigation mark, and identifies that a light detected not to have cyclicity is identified as a light of a navigation light installed in a vessel.

3. The image processing apparatus according to claim 2, wherein, for a light identified as a light of a navigation mark, a navigation mark type corresponding to the light is further identified based on a light color of the light, a cycle of a temporal change, and a light emission pattern.

4. The image processing apparatus according to claim 3, wherein a label indicating the identified navigation mark type is overlapped on a navigation mark image included in the invisible light video corresponding to the light identified as the light of the navigation mark.

5. The image processing apparatus according to claim 3, wherein an image indicating the light emission pattern of the light is overlapped on the navigation mark image included in the invisible light video corresponding to the light identified as the light of the navigation mark.

6. The image processing apparatus according to claim 3, wherein a color corresponding to the identified navigation mark type is overlapped on a navigation mark image included in the invisible light video corresponding to the light identified as the light of the navigation mark.

7. The image processing apparatus according to claim 2, wherein the one or more processors further executing the instructions to determine, for a light identified as a light of a navigation light, one or more lights having a mutual distance less than a predetermined distance in a video as one or more lights installed in identical vessels, and groups the one or more lights.

8. The image processing apparatus according to claim 7, wherein, for the grouped one or more lights, an orientation of the vessel in which the one or more lights are installed is further identified, based on a light color and a positional relationship of each of the one or more lights.

9. The image processing apparatus according to claim 8, wherein an icon indicating the identified orientation of the vessel is overlapped on a vessel image included in the invisible light video corresponding to a light identified as a navigation light.

10. The image processing apparatus according to claim 7, wherein the detected color is overlapped on each of one or more light positions of a vessel image included in the invisible light video corresponding to a light identified as a navigation light.

11. An image capturing apparatus comprising:
the image processing apparatus according to claim 1;
the visible light image capturing unit; and
the invisible light image capturing unit.

12. An image capturing system comprising:
the image capturing apparatus according to claim 11; and
a display apparatus that displays an invisible light video on which information is overlapped, the invisible light video being obtained from the image capturing apparatus.

13. A control method for an image processing apparatus, the control method comprising:
obtaining a visible light video generated by a visible light image capturing unit that performs image capturing in a wavelength range of visible light;
obtaining an invisible light video generated by an invisible light image capturing unit that performs image capturing in a wavelength range different from the wavelength range of the visible light;
detecting cyclicity of a temporal change of one or more lights included in a video from the video of at least one of the visible light video and the invisible light video;
detecting a color of the one or more lights from the visible light video;
identifying a type of at least one light of the one or more lights based on the detected cyclicity and the detected color; and
overlapping information regarding the identified type on the invisible light video.

14. A non-transitory computer-readable recording medium storing a program that, when executed by a computer, causes the computer to perform a control method for an image processing apparatus, the control method comprising:
obtaining a visible light video generated by a visible light image capturing unit that performs image capturing in a wavelength range of visible light;
obtaining an invisible light video generated by an invisible light image capturing unit that performs image capturing in a wavelength range different from the wavelength range of the visible light;
detecting cyclicity of a temporal change of one or more lights included in a video from the video of at least one of the visible light video and the invisible light video;
detecting a color of the one or more lights from the visible light video;
identifying a type of at least one light of the one or more lights based on the detected cyclicity and the detected color; and
overlapping information regarding the identified type on the invisible light video.
